(19) United States
(12) Patent Application Publication
(10) Pub. No.: US 2013/0317849 A1
(43) Pub. Date: Nov. 28, 2013

(54) COMPUTER PROGRAM, METHOD, AND SYSTEM FOR COLLECTING MANAGING, AND ANALYZING ORAL HEALTH CARE DATA

(71) Applicant: Loretta J. Seidl, Lawrence, KS (US)

(72) Inventor: Loretta J. Seidl, Lawrence, KS (US)

(73) Assignee: BLISS & Associates, LLC, Lawrence, KS (US)

(21) Appl. No.: 13/481,456

(22) Filed: May 25, 2012

(51) Int. Cl. G06Q 50/24

(52) U.S. Cl. 705/3

(57) ABSTRACT

A computer program stored on non-transitory computer-readable medium for directing operation of a computer system for use in collecting, managing, and analyzing dental or oral health care data for residents in an assisted living facility. The computer program comprises a code segment for receiving and storing in the computer system profile data for at least some of the residents in the facility; a code segment for permitting caregivers at the facility to access the profile data; a code segment for receiving from the caregivers health care data representative of dental or oral health care provided to the residents; a code segment for tracking when each caregiver uses the computer program to access the profile data or enter the health care data; and a code segment for providing a report that indicates how often each caregiver accessed the profile data or entered the health care data.

### BACKGROUND

Many older adults live in retirement homes (also known as nursing homes, long term care facilities, assisted living facilities, etc.) Studies have shown that the dental and oral health care needs of those residing in such facilities are often not adequately met due to several factors, including: a lack of knowledge of the importance of dental and oral health care on the part of the residents, their families, and caregivers; physical and/or mental limitations of the residents that prevent them from providing self care; and poor record keeping and tracking of the care that is provided.

In an attempt to improve the dental and oral health care of their residents, some retirement homes collect and analyze data related to the residents' current oral health condition and the provision of oral health care to the residents. Traditionally, such data has been collected manually with notes and/or hash marks made on paper sheets. These paper sheets are then placed in the residents' charts for future use.

### SUMMARY

Applicant has discovered that the above-described manual data collection processes are laborious and error prone. Manual data collection methods can also lead to duplicate or missing data and typically don't track when and by whom the data was collected.

Manual data collection methods also fail to coordinate the efforts of the resident's daily caregivers with dentists or other medical professionals. For example, records kept by a retirement home may not indicate that a resident has recently had teeth extracted by a dentist, causing caregivers at the facility to be unaware of possible problems the resident may have such as bleeding, food impaction and sensitivity of the area. It is extremely important for the caregiver to know this information while administering daily oral health care to the resident.

Manual analysis of oral health care data is also time consuming and results in long delays between when the data was collected and when it is able to be viewed for analysis after being compiled and entered into spreadsheets. Moreover, most software is not specifically designed to analyze this type of data, so administrators and caregivers are limited in the way the data can be analyzed.

The lack of effective data collection, management, and analysis methods can result in inadequate oral and dental health care, which in turn can reduce the quality of life for residents in nursing homes and impose extra burdens and costs on the facilities. These problems also burden hospitals and others not directly related to nursing homes. For example, some elderly residents with severe dental or oral pain are sometimes taken to hospital emergency rooms where they are treated for their pain but not for the underlying dental or oral health problems. The same residents are often taken back to the emergency rooms when their pain returns, unnecessarily costing the hospitals, insurance companies and taxpayers great sums of money without resolving the underlying medical problem.

The present invention solves at least some of the above-described problems and provides a distinct advance in the art of dental and oral health care data collection, management, and analysis techniques for nursing homes by providing a computer program, method, and system designed specifically for this purpose.

An embodiment of the invention is a computer program for use in collecting, managing, and analyzing dental and oral health care data for residents in a facility. The computer program may comprise a code segment for receiving and storing profile data for at least some of the residents; a code segment for permitting caregivers at the facility to access the profile data; a code segment for receiving from the caregivers health care data representative of dental or oral health care provided to the residents; a code segment for tracking when each caregiver uses the computer program to access the profile data or enter the health care data; and a code segment for providing a report that indicates how often each caregiver accessed the profile data or entered the health care data. By providing a computer program specifically designed for use in collecting dental or oral health care data for residents in a facility, and by tracking use of the program by caregivers in the facility, the invention encourages use of the program and consequentially improves not only record-keeping at the facility, but also the dental or oral health care provided to the residents. Daily oral care is a vital part of the overall care for the residents to provide optimum overall health and also reduce cost to the residents and facility.

Another embodiment of the invention is also a computer program for use in collecting, managing, and analyzing dental and oral health care data for residents in a facility. This embodiment of the computer program comprises a code segment for receiving and storing profile data for all residents in the nursing home from the time of their initial assessment, wherein the profile data includes each resident's name, facility room number, admission date, and a status indicator. In one embodiment, a resident's oral health status indicator indicates the resident is either a) able to maintain his or her oral hygiene independently; b) in need of a reminder to perform oral hygiene; c) in need of assistance with oral hygiene; or d) in need of a caregiver to perform oral hygiene for him or her. The computer program also comprises a code segment for permitting caregivers at the facility to access the profile data; a code segment for receiving from the caregivers health care data representative of dental or oral health care provided to the residents; and a code segment that allows an administrator or other person to search the profile data to identify residents with common characteristics. For example, the profile data may be searched to identify residents with the same status indicator or a similar admission date. This allows an administrator to better manage the dental or oral health care of each resident and to coordinate appropriate staffing levels for the overall facility. For example, if a high percentage of the residents cannot perform their own oral hygiene, the administrator knows that additional caregivers may be needed for this purpose. Similarly, if a large number of residents have been admitted to the facility recently, the administrator knows that many of the residents may need initial oral health care assessments and/or educational instructions. After the initial assessment, the residents may be assessed on a quarterly basis to maintain updated oral health records, as well as to comply with federal mandates.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram that illustrates persons and/or entities that may be involved with aspects of the present invention.

FIG. 2 is a schematic diagram of exemplary computer and communications equipment that may be used to implement embodiments of the invention.

FIG. 3 is an exemplary screen display that may be presented by one or more computer programs of the present invention.

FIG. 4 is another exemplary screen display that may be presented by one or more computer programs of the present invention.

FIG. 5 is another exemplary screen display that may be presented by one or more computer programs of the present invention.

FIG. 6 is another exemplary screen display that may be presented by one or more computer programs of the present invention.

FIG. 7 is another exemplary screen display that may be presented by one or more computer programs of the present invention.

FIG. 8 is another exemplary screen display that may be presented by one or more computer programs of the present invention.

FIG. 9 is another exemplary screen display that may be presented by one or more computer programs of the present invention.

FIG. 10 is another exemplary screen display that may be presented by one or more computer programs of the present invention.

FIG. 11 is another exemplary screen display that may be presented by one or more computer programs of the present invention.

FIG. 12 is another exemplary screen display that may be presented by one or more computer programs of the present invention.

FIG. 13 is another exemplary screen display that may be presented by one or more computer programs of the present invention.

FIG. 14 is another exemplary screen display that may be presented by one or more computer programs of the present invention.

FIG. 15 is another exemplary screen display that may be presented by one or more computer programs of the present invention.

FIG. 16 is another exemplary screen display that may be presented by one or more computer programs of the present invention.

FIG. 17 is another exemplary screen display that may be presented by one or more computer programs of the present invention.

FIG. 18 is another exemplary screen display that may be presented by one or more computer programs of the present invention.

FIG. 19 is an exemplary report that may be generated by one or more computer programs of the present invention.

FIG. 20 is another exemplary report that may be generated by one or more computer programs of the present invention.

FIG. 21 is another exemplary report that may be generated by one or more computer programs of the present invention.

FIG. 22 is another exemplary report that may be generated by one or more computer programs of the present invention.

FIG. 23 is another exemplary report that may be generated by one or more computer programs of the present invention.

FIG. 24 is another exemplary report that may be generated by one or more computer programs of the present invention.

FIG. 25 is another exemplary report that may be generated by one or more computer programs of the present invention.

FIG. 26 is another exemplary report that may be generated by one or more computer programs of the present invention.

FIG. 27 is another exemplary report that may be generated by one or more computer programs of the present invention.

FIG. 28 is another exemplary report that may be generated by one or more computer programs of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, ‘an embodiment”, or “embodiments” in this description do not necessarily refer to the same embodiment and are also not mutually exclusive unless so stated and/or except as will be readily apparent to those skilled in the art from the description. For example, a feature, act, etc. described in one embodiment may also be included in other embodiments, but is not necessarily included. Thus, the present technology can include a variety of combinations and/or integrations of the embodiments described herein.

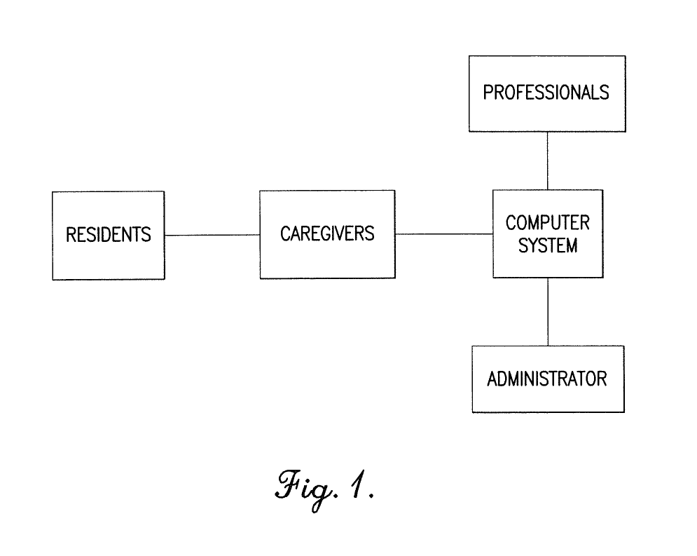

FIG. 1 is a block diagram that illustrates the relationships between persons and/or entities that may be involved with aspects of the invention. The entities include residents in a nursing home, a number of caregivers at the facility, and an administrator that operates a computer system that is used to collect, manage, and analyze oral health care data, and possible professionals such as dentists, oral surgeons, and doctors. As used herein, “nursing home” or “facility” encompasses any facility that cares for older adults and others who want or need some assistance with health care, hygiene, and/or other requirements.

The residents may be older adults or any other persons living in a retirement home. The residents may reside in the facility full time or temporarily (while being rehabilitated) and may receive some assistance with medical care and/or hygiene while at the facility.

The caregivers may be any persons who are trained to assist with the dental or oral health care, oral hygiene, and/or other medical care of the residents. The caregivers typically work with the residents under the direction of the professionals and/or the administrator.

The administrator may be any person or entity that organizes the activities of the residents, caregivers, and professionals. The administrator may also operate a computer system that can be accessed by the caregivers, professionals and/or others as described below. The administrator may be, for example, an operator or manager of a retirement home.

The professionals may be dentists, oral surgeons, dental hygienists, medical doctors, nurses, who have professional training, education, and/or licenses in dentistry or oral medicine. The professionals may work directly for the nursing home or may be independent and provide oral care or medical care to the residents on a referral/consulting basis.

Some aspects of the invention are preformed primarily by the caregivers, other aspects are performed primarily by the professionals, and still other aspects are performed by the administrator. However, some aspects of the invention may be performed by any of these persons. As used herein, “persons”, “users’, “staff”, and “staff members” may encompass the profile data or entered the health care data.

Many older adults live in assisted living facilities (also known as retirement homes, senior housing, and nursing homes). Studies have shown that the dental and oral health care needs of those residing in such facilities are often not adequately met due to several factors, including: a lack of knowledge of the importance of dental and oral health care on the part of the residents, their families, and caregivers; physical and/or mental limitations of the residents that prevent them from providing self care; and poor record keeping and tracking of the care that is provided.

In an attempt to improve the dental and oral health care of their residents, many assisted living facilities collect and analyze data related to the residents' current oral health condition and the provision of oral health care to the residents. Traditionally, such data has been collected manually with notes and/or hash marks made on paper sheets. These paper sheets are then typically given to assistants to manually enter into programs (such as Microsoft Excel) that are not specifically designed to analyze the data.

“Dental health care”, “oral health care”, “oral hygiene”, and similar terms are sometimes used interchangeably herein and all are meant to encompass any dental or oral hygiene or care performed by the residents or provided to the residents by the caregivers or professionals.

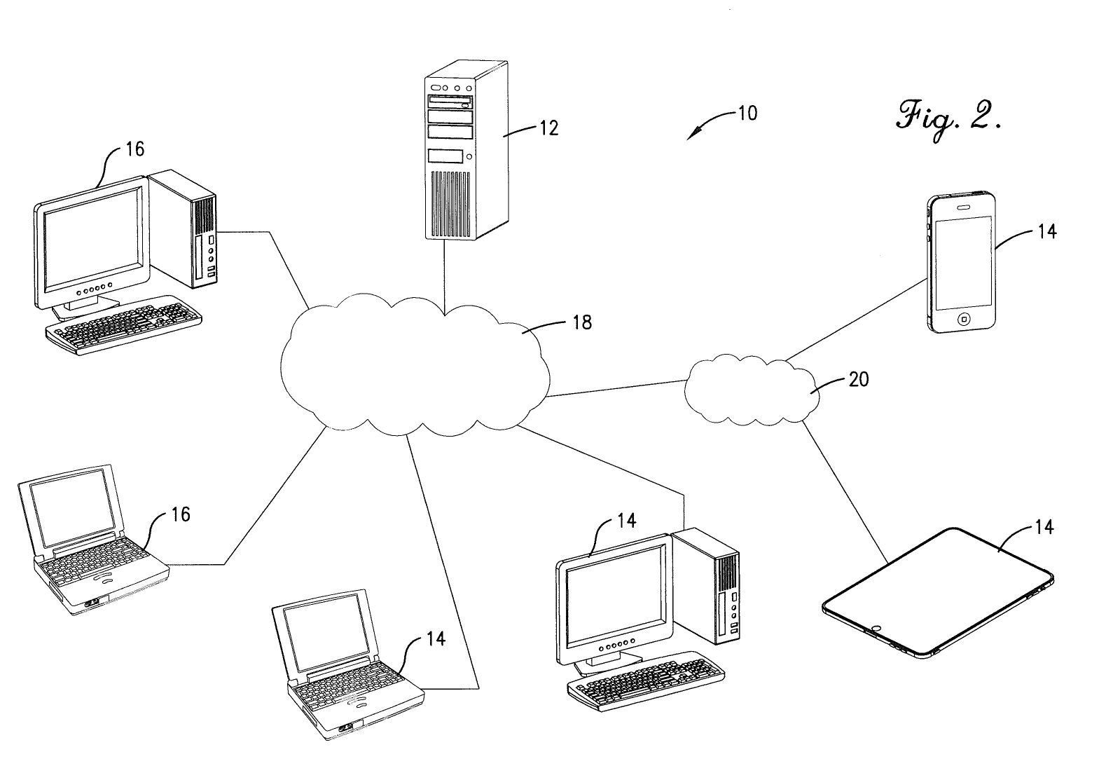

Aspects of the invention can be implemented with computer hardware, software, firmware, or a combination thereof. In one embodiment, aspects of the invention may be at least partially implemented with a system of computer and communications equipment broadly referred to by the numeral 10 in FIG. 2. An embodiment of the computer and communications equipment 10 includes a computer system 12 operated by or for the administrator, a number of electronic devices 14 operated by the caregivers, a number of electronic devices 16 operated by or for the professionals, a communications network 18, and a wireless telecommunications network 20. The components of the computer and communication equipment 10 illustrated and described herein are merely examples of equipment that may be used to implement embodiments of the present invention and may be replaced with other equipment without departing from the scope of the present invention.

The computer system 12 receives and stores dental and oral health care data and other information from the electronic devices 14, 16, or other computing devices, manages and analyzes the data, and may be accessed by the devices 14, 16 and other devices to obtain reports relating to the data. The computer system 12 implements one or more computer programs for performing some of the functions described herein.

Embodiments of the computer system 12 may include one or more servers such as a web server, a database server, an application server, and/or an FTP server running Windows; LAMP (Linux, Apache HTTP server, MySQL, and PHP/Perl/Python); Java; AJAX; NT; Novel Netware; Unix; or any other software system. The computer system 12 includes or has access to computer memory and other hardware and software for receiving, storing, accessing, and transmitting data and other information as described below. The computer system 12 also includes conventional web hosting operating software, searching algorithms, an Internet connection, and may be assigned a URL and corresponding domain name such as “bliss.com” so that it can be accessed via the Internet in a conventional manner.

The number and type of servers or other computers in the computer system 12 is a matter of design choice and may depend on the number of residents, caregivers, and professionals served by the computer system 12. Thus, the invention is not limited to the specific servers and other equipment described and illustrated herein. Similarly, any number of the electronic devices 14, 16 may be served by the computer system 12.

In accordance with one important aspect of the invention, the computer system 12 may host or store profile data for each resident in a facility. The profile data may include the resident's name, facility room number, admission date, and a status indicator. In one embodiment, a resident's status indicator indicates the resident is a) able to maintain his or her oral hygiene independently; b) in need of a reminder to perform oral hygiene; c) in need of assistance with oral hygiene; or d) in need of a caregiver to perform oral hygiene for him or her. The profile data may also include dental or oral health care data stored in a number of reports as described below.

The computer system 12 may also host and support software and services of proprietary mobile application providers such as Google, Apple, and Blackberry and may store computer programs that may be loaded on the electronic devices 14, 16.

The electronic devices 14 may be any computer devices used by the caregivers to collect or view data related to the residents' dental or oral health conditions and/or oral health care. For example, the electronic devices 14 may be laptop computers, desktop computers, or other personal computers. The electronic devices may also be tablet computers or smart phones such as those sold by Apple®, Motorola®, Samsung® or Hewlett Packard®. Each of the electronic devices 14 may include an Internet browser and a conventional Internet connection such as a wireless broadband connection, a modem, DSL converter, or ISDN converter to access the computer system 12 via the communications networks 18 and/or 20.

Likewise, the electronic devices 16 may be any computer devices used by or for the professionals. For example, the electronic devices 16 may be laptop computers, desktop computers or other personal computers or even tablet computers or smart phones. The electronic devices 16 may each include an Internet browser and a conventional Internet connection such as a wireless broadband connection, a modem, DSL converter, or ISDN converter to access the computer system 12 via the communications networks 18 and/or 20.

The communications network 18 may be any network that permits data transfer between the computer system 12 and the electronic devices 14, 16. For example, the communications network 18 may be a local area network, a wide area network, an intranet or the Internet. The wireless network 20 may be any network capable of supporting wireless communications such as the wireless networks operated by AT&T, Verizon, or Sprint. The wireless network 20 may include conventional switching and routing equipment. The communications network 18 and wireless network 20 may also be combined or implemented with several different networks.

Embodiments of the present invention also comprise one or more computer programs stored in or on computer-readable medium residing on or accessible by the computer system 12 and/or the electronic devices 14, 16. The computer programs may comprise listings of executable instructions for implementing logical functions in the computer equipment. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

An embodiment of the invention includes a computer program for directing operation of the computer system 12 for collecting, managing, and analyzing dental or oral health care data for residents in a facility. The computer program may comprise a code segment for receiving and storing in the computer system profile data for at least some of the residents; a code segment for permitting caregivers at the facility to access the profile data; a code segment for receiving from the caregivers health care data representative of dental or oral health care provided to the residents; a code segment for tracking when each caregiver uses the computer program to access the profile data or enter the health care data; and a code segment for providing a report that indicates how often each caregiver accessed the profile data or entered the health care data.

Another embodiment of the invention also includes a computer program for directing operation of the computer system 12 for collecting, managing, and analyzing dental or oral health care data for residents in a facility. This embodiment of the computer program comprises a code segment for receiving and storing in the computer system 12 the profile data described above. The computer program also comprises a code segment for permitting caregivers at the facility to access the profile data; a code segment for receiving from the caregivers health care data representative of dental or oral health care provided to the residents; and a code segment that allows an administrator or other person to search the profile data to identify residents with common characteristics. In one embodiment, the profile data may be searched to identify residents with the same status indicator or similar admission date. This allows an administrator to better manage the oral health care of each resident and to coordinate appropriate staffing levels for the overall facility. For example, if a high percentage of the residents cannot perform their own oral hygiene (brushing, flossing, rinsing), the administrator knows that additional caregivers may be needed for this purpose. Similarly, if a large number of residents have been admitted to the facility recently, the administrator knows that many of the residents may need initial oral health care assessments and/or educational instructions.

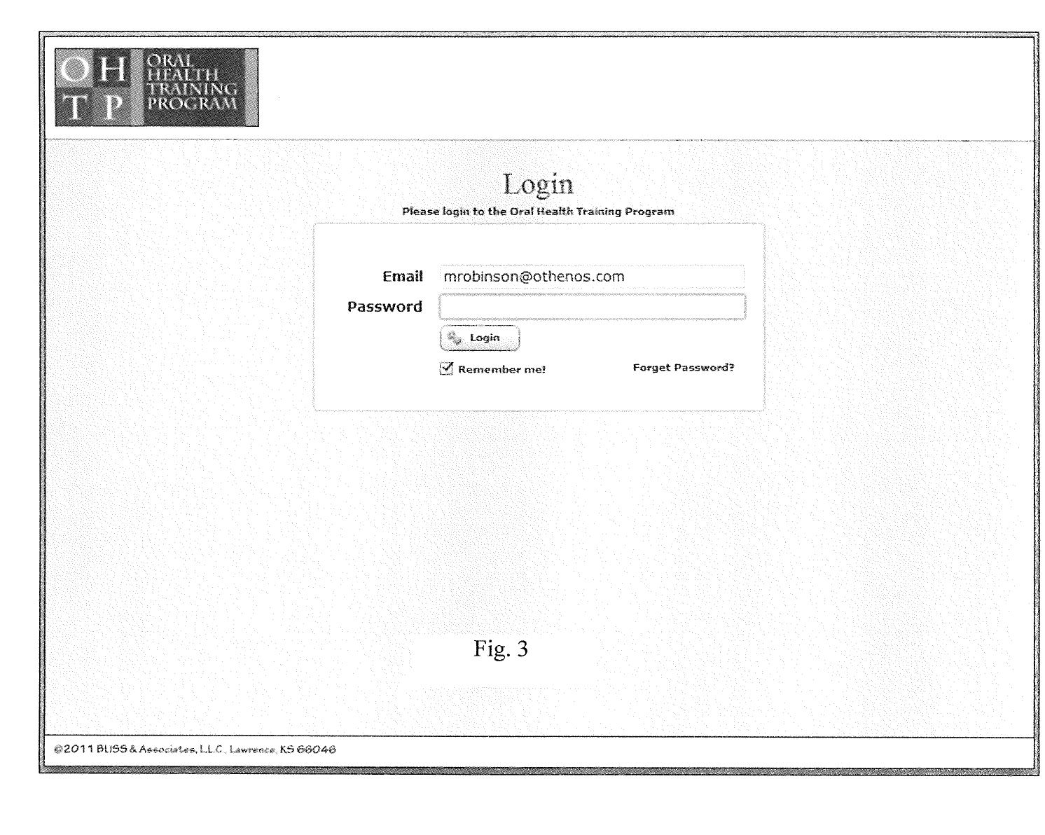

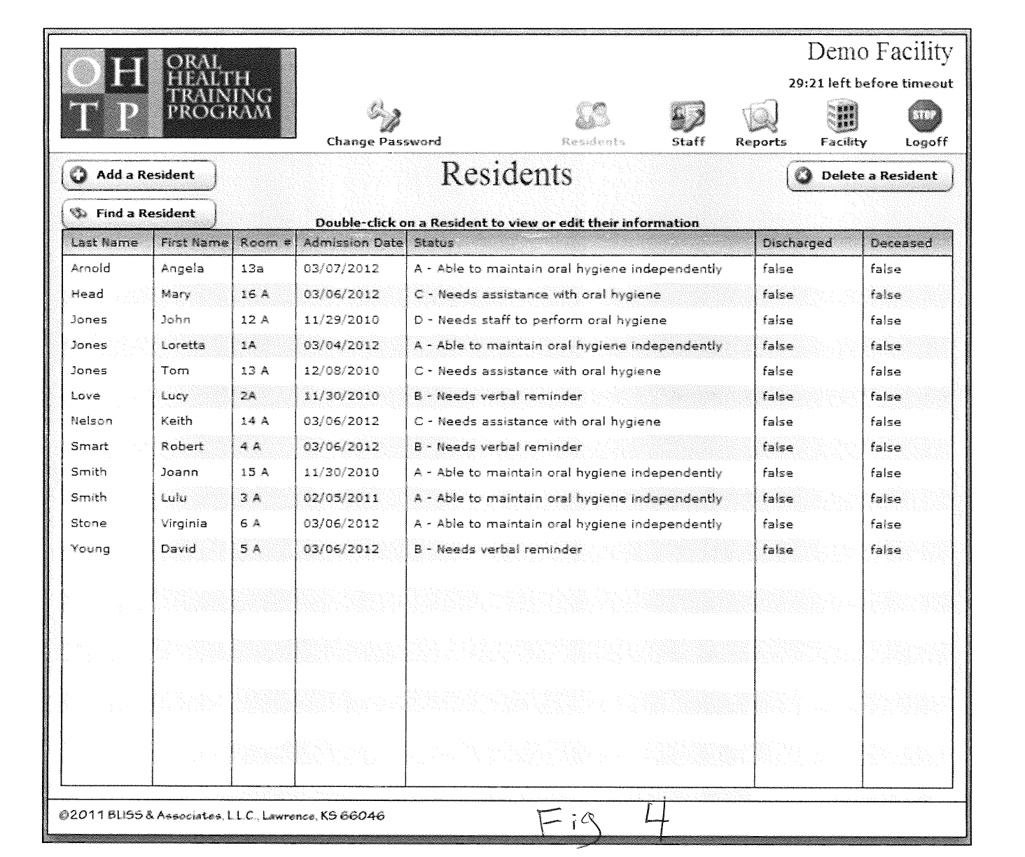

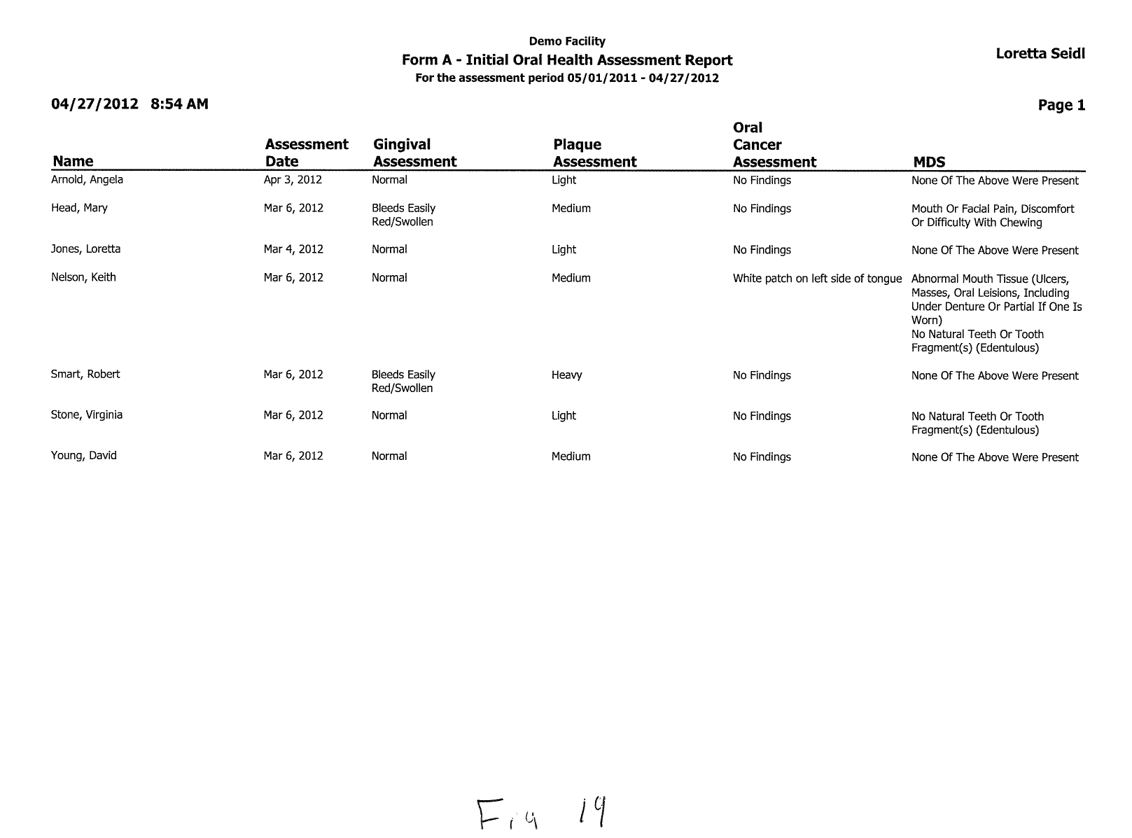

Specific embodiments of the computer programs will now be described with reference to the screen shots of FIGS. 3-18 and the exemplary reports shown in FIG. 19-28. A caregiver or professional using one of the devices 14, 16 may access the computer system 12 and log-in to the computer program by opening the program and entering an e-mail address and password as shown in FIG. 3. Upon log-in, the computer system may display a main or home screen as shown in FIG. 4. The home screen has tabs or links in the upper right side for Residents, Staff, Reports, Facility, and Logoff. The home screen defaults to the Residents screen as shown in FIG. 4.

The Residents screen may list all the residents in a facility along with some of the profile data for each resident. As shown, the Residents screen lists the resident's name, facility room number, admission date, and a status indicator, and may indicate whether the resident has been discharged or is deceased. A user may click on any of the listed resident names to obtain more detailed profile data and other information.

As explained above, the status indicator indicates a resident's oral health status, such as whether he or she is a) able to maintain his or her oral hygiene independently (status A); b) in need of a reminder to perform oral hygiene (status B); c) in need of assistance with oral hygiene (status C); or d) in need of a caregiver to perform oral hygiene for him or her (status D). These status indicators are assigned during an initial assessment of each resident and may be changed as described below.

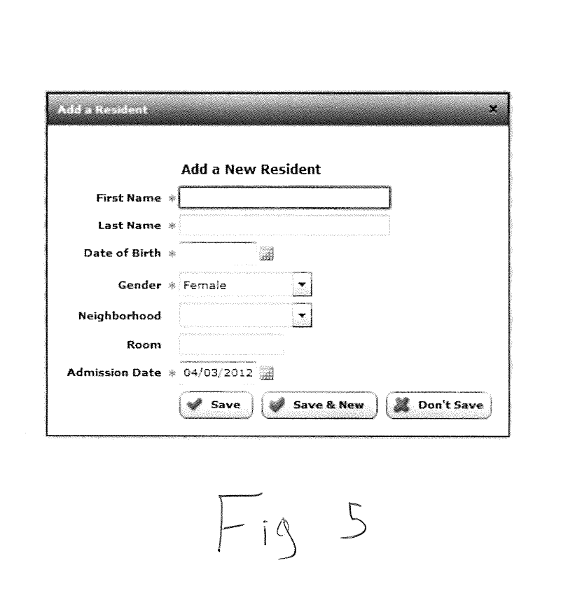

The Residents screen also has an Add a Resident button or icon in the upper left side that links to a screen used to add profile data for a new resident as shown in FIG. 5. A user may populate the fields shown in FIG. 5 and then save the entered data to create a new profile and/or may upload the data or similar data from another source.

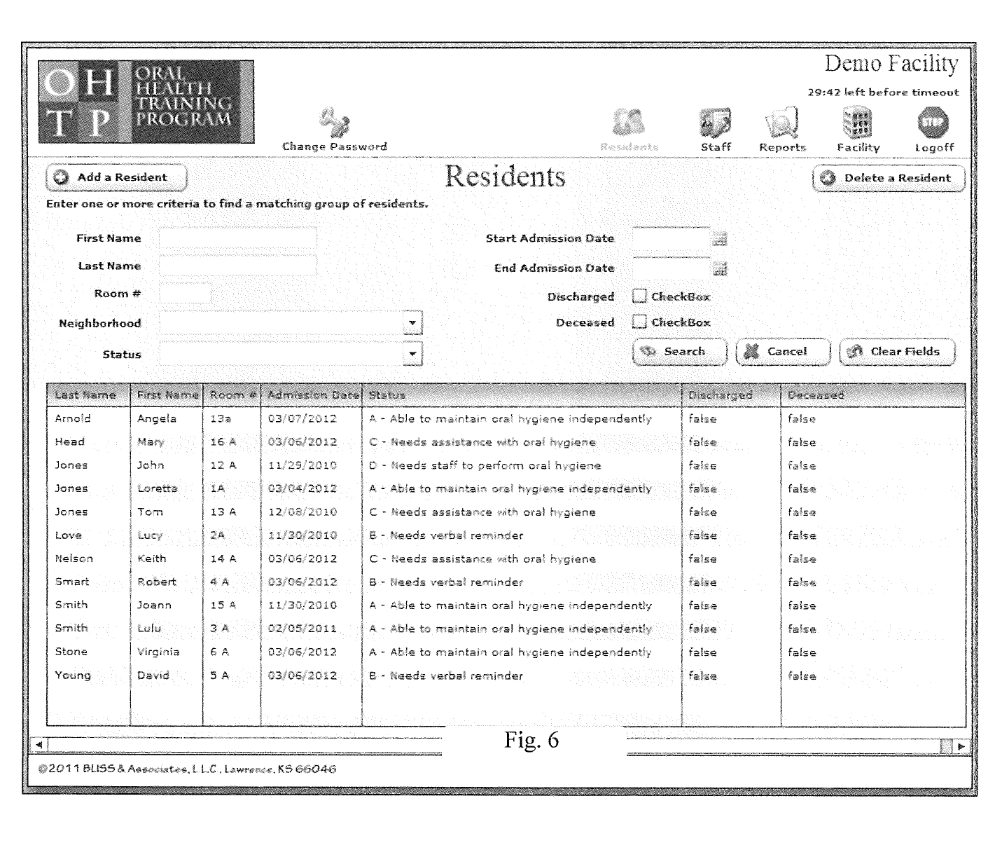

The Residents screen of FIG. 4 also has a Find a Resident button or icon in the upper left side that links to a screen used to find an existing resident or residents as shown in FIG. 6. The administrator or other person may search for residents based on name, room number, or other criteria. For example, the profile data can be searched to identify all residents with the same status indicator or with an admission date within a selected date range.

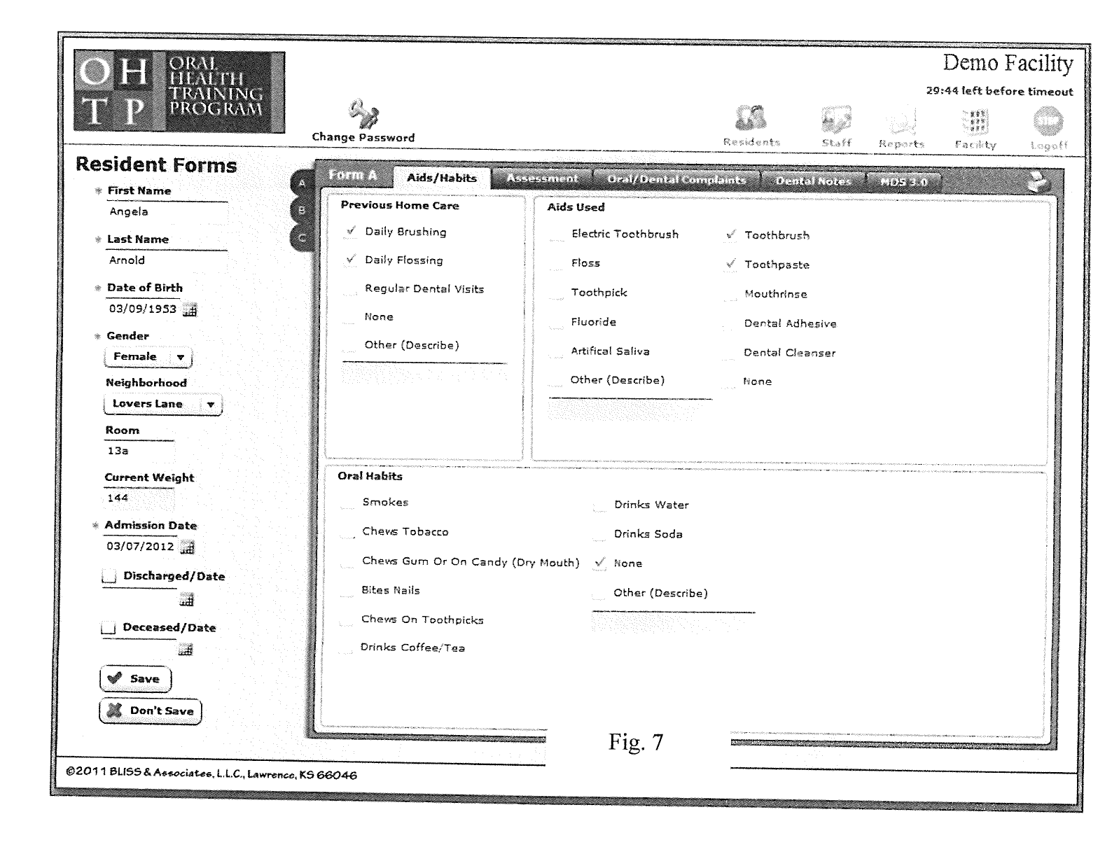

A caregiver, the administrator, or another person may also click on one of the resident's names in FIG. 4 to display and/or edit more of the resident's profile information. In one embodiment, doing so links to a screen such as the one shown in FIG. 7. This screen provides access to four forms called: Form A, Form B, Form C, and Form D. The screen defaults to Form A. The fauns may of course have other names.

Form A is an initial assessment form and is filled out when a resident is first admitted to a facility. As shown in FIG. 7, Form A has tabs or links for Aids/Habits, Assessment, Oral/Dental Complaints, Dental Notes, and MDS.

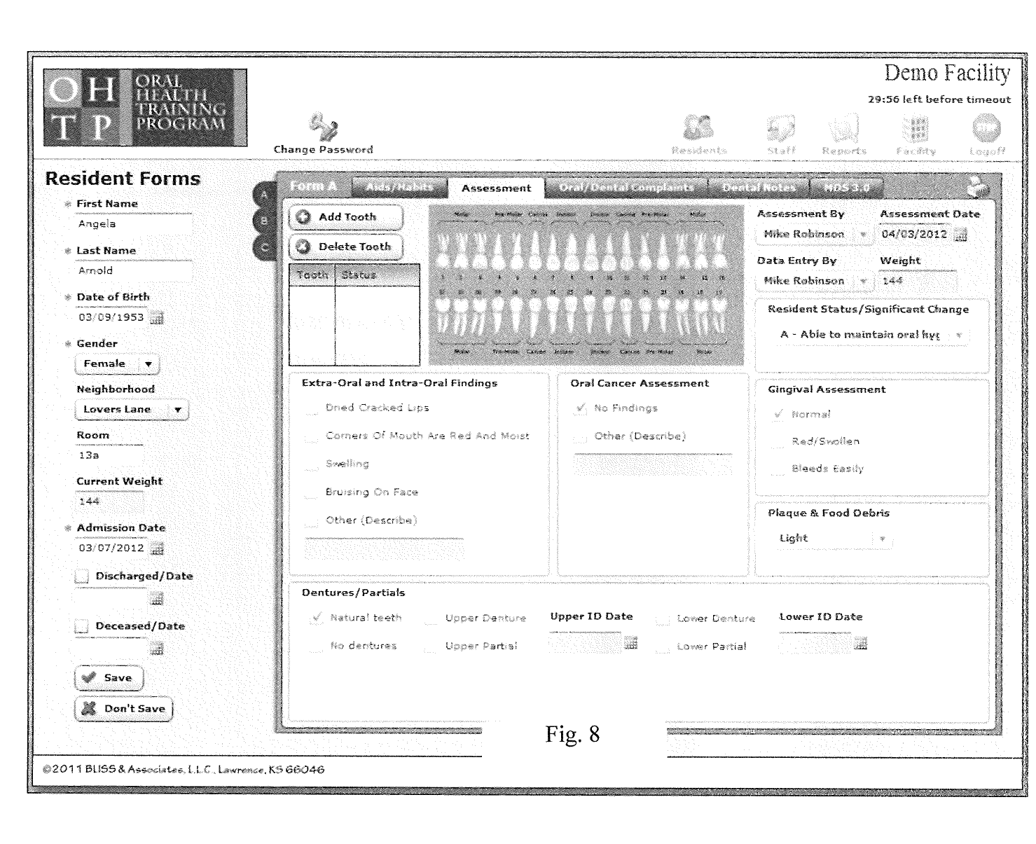

The Aids/habits tab links to the default page of FIG. 7 and permits a user to indicate a resident's previous home care; aids used for oral health care; and oral habits. The Assessment tab links to a page shown in FIG. 8 that permits a user to assess a resident's current oral health conditions. For example, the page allows a user to indicate existing and missing teeth, the status of the teeth, extra-oral and intra-oral findings, oral cancer findings, a gingivitis assessment, a plaque/debris assessment, and the existence of and type of dentures.

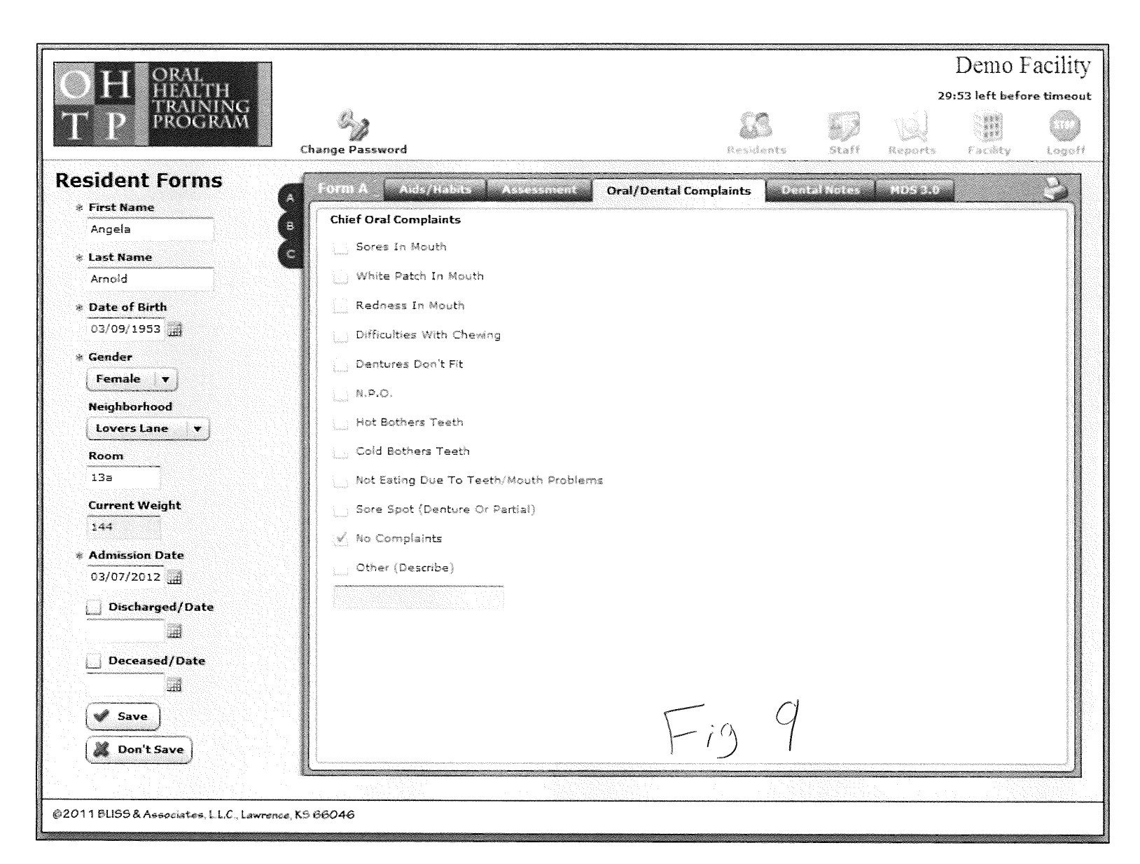

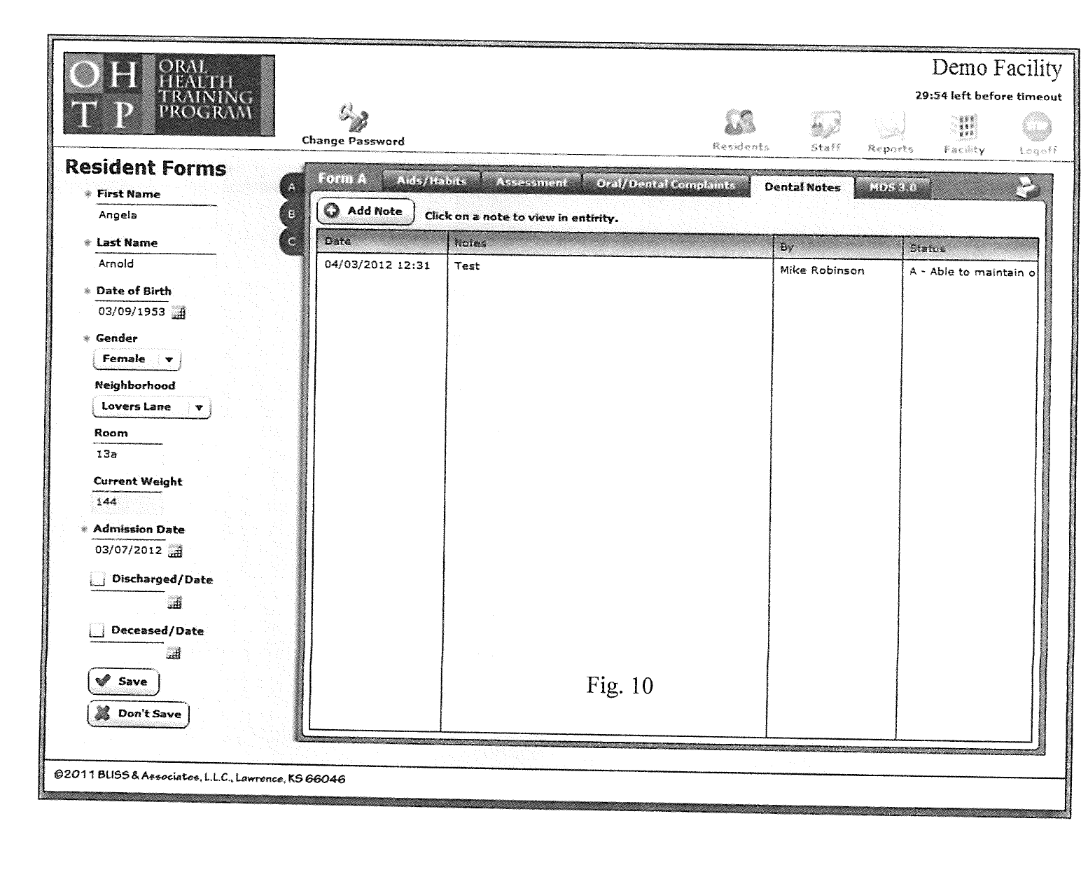

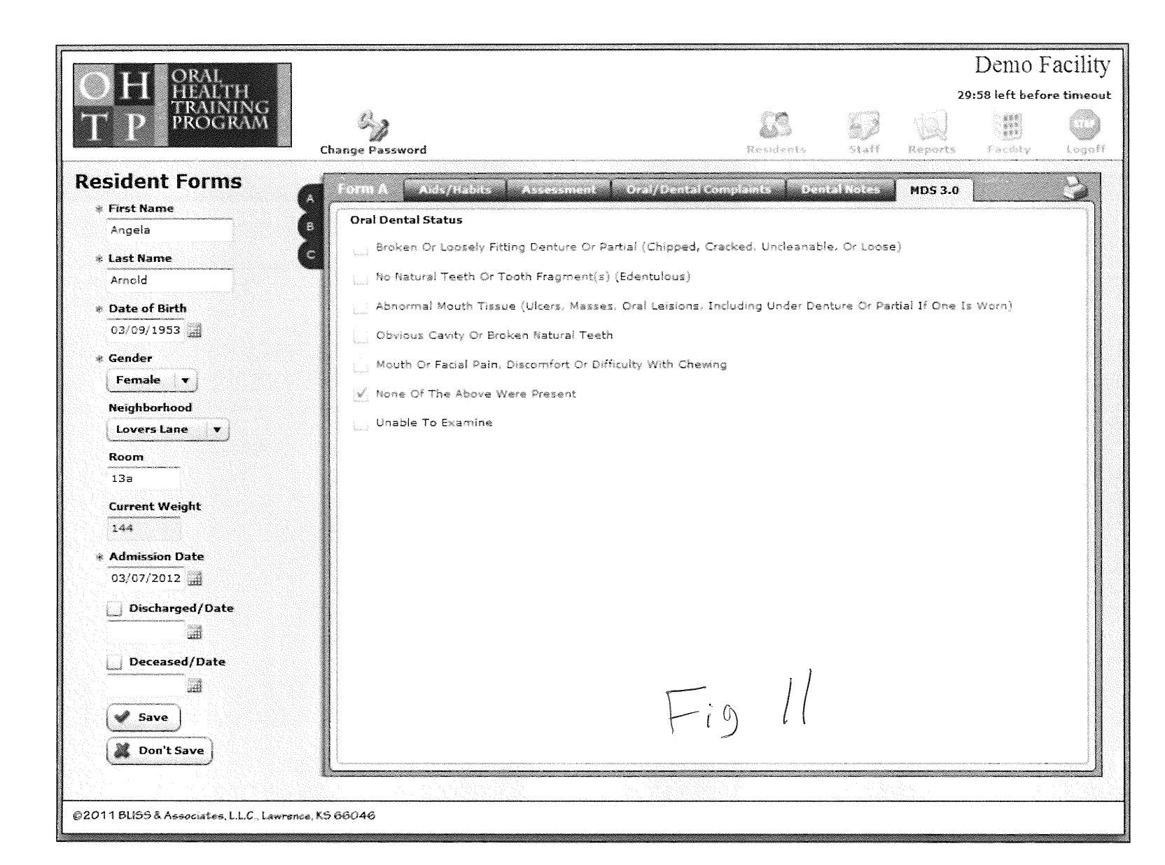

The Oral/Dental Complaints tab links to a page shown in FIG. 9 that allows a user to identify a resident's primary dental or oral health problems. The Dental Notes tab links to a page shown in FIG. 10 that allows a user to add notes relating to a resident's oral or dental health condition. The MDS tab links to a page shown in FIG. 11 that allows a user to indicate the status of dental or oral health issues for a resident for a minimum data set (MDS) of information.

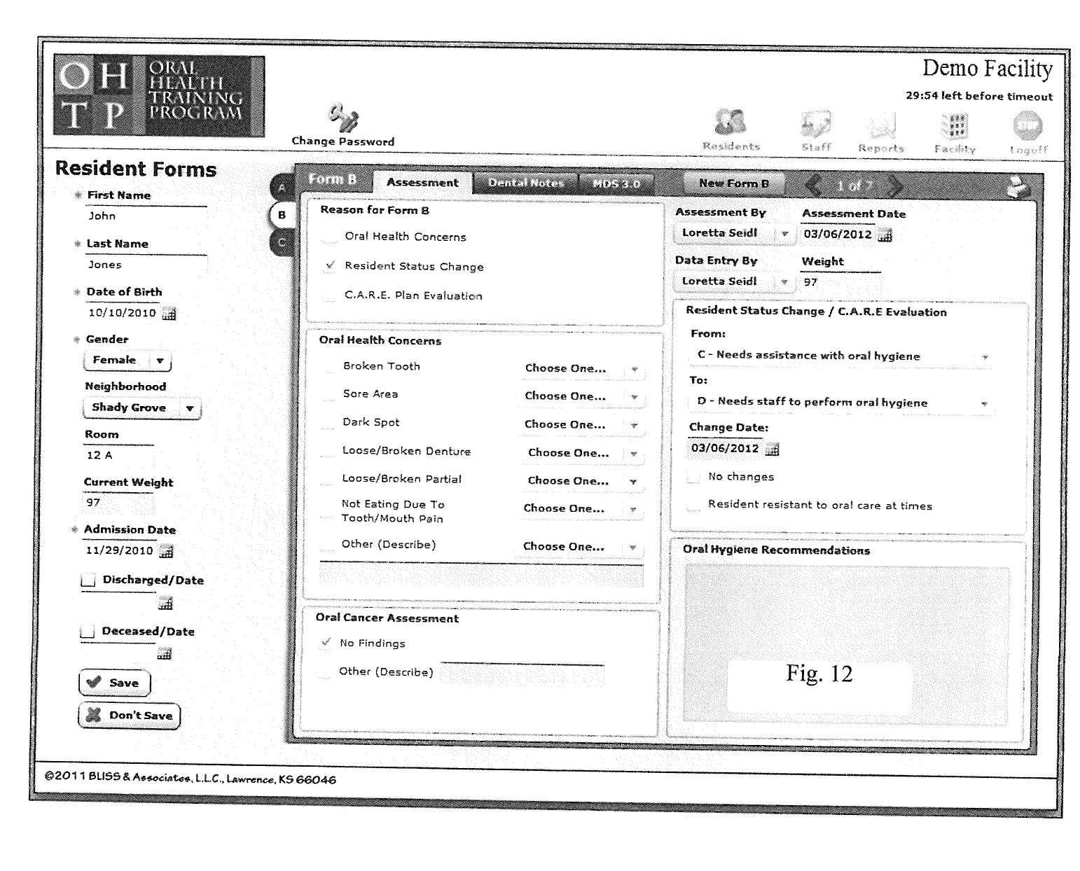

Form B may be accessed by clicking on the “B” tab in FIG. 7. This form provides an updated assessment for a resident and is typically filled out when the resident receives a quarterly health care assessment, has a changed status indicator, or has a dental problem requiring referral to a dentist. As shown in FIG. 12, Form B has tabs or links for Assessment, Dental Notes, and MDS. The Assessment tab links to the default page of FIG. 12 and allows a user to identify a reason for the updated assessment data and to note oral health concerns of the resident. The page also allows the user to indicate a changed status indicator and the date of the change and to provide an oral cancer assessment.

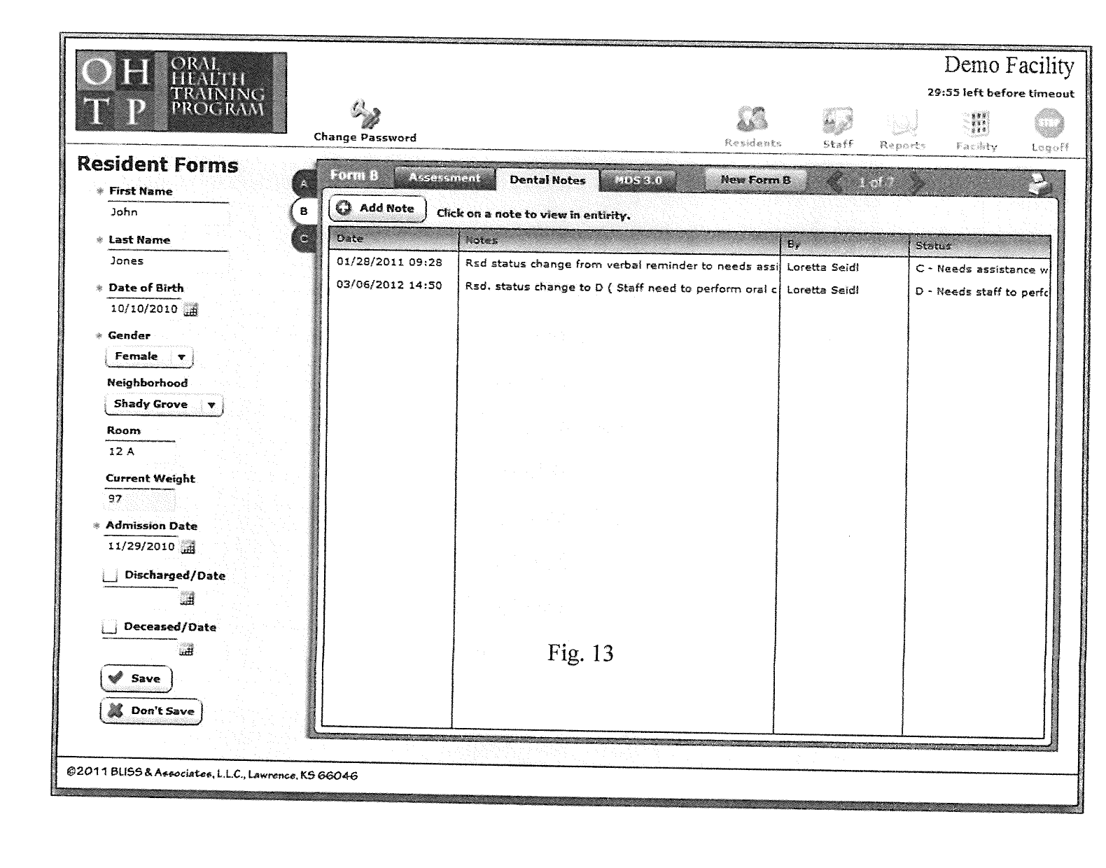

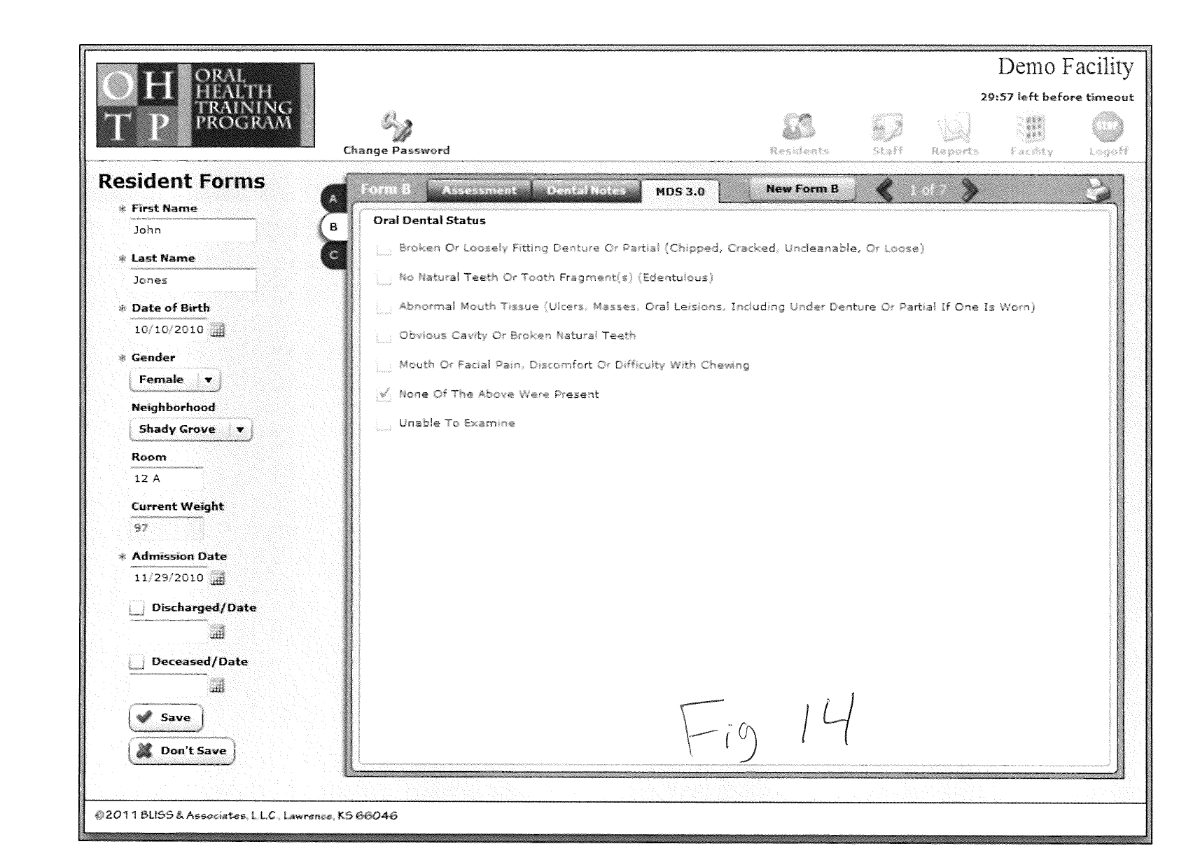

The Dental Notes tab links to a page shown in FIG. 13 that allows a user to add notes relating to a resident's oral or dental health condition. The MDS tab links to a page shown in FIG. 14 that allows a user to indicate the minimum data set (MDS) of information mentioned above.

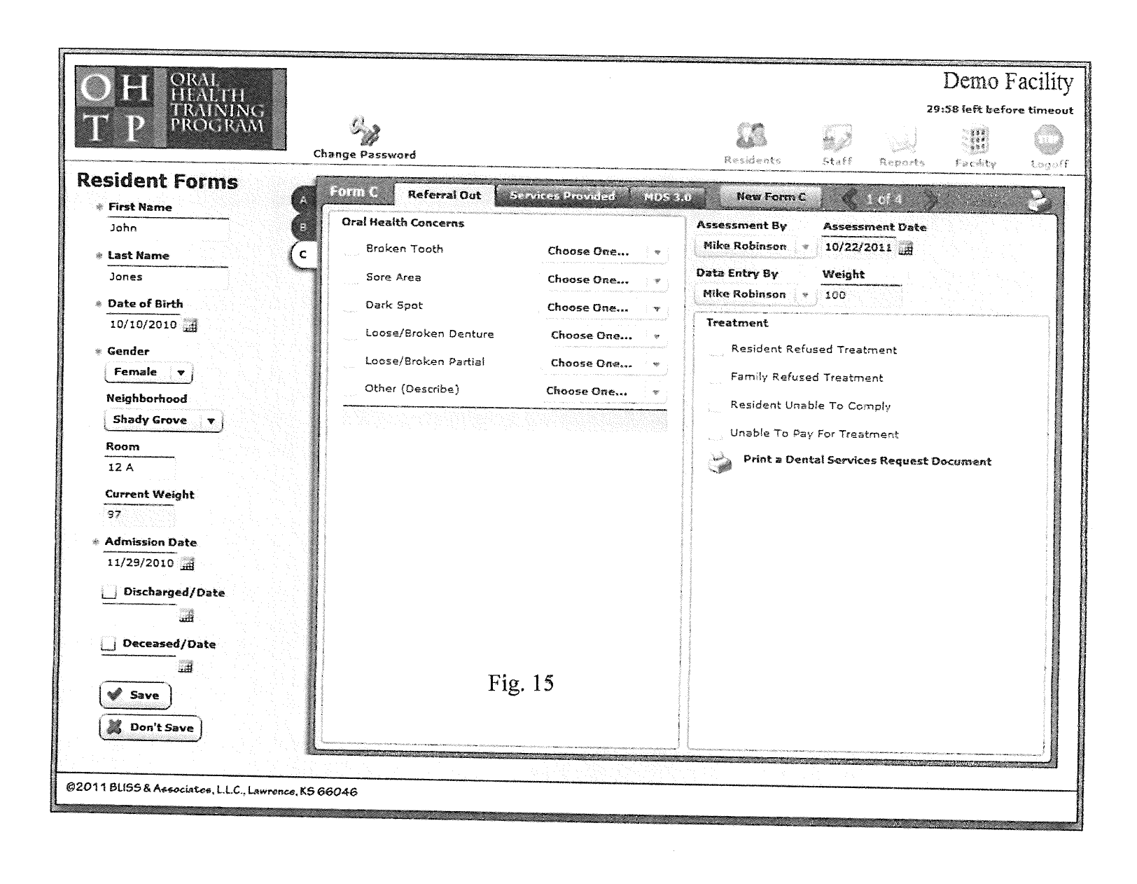

Form C may be accessed by clicking on the “C” tab in FIG. 7. This is a referral form and is typically filled out by a caregiver when an oral health problem is noted for a resident that requires care from a dentist or other professional. As shown in FIG. 15, Form C has tabs or links for Referral Out, Services Provided, and MDS.

The Referral Out tab links to the default page of FIG. 15 and allows a user to indicate the oral health concern that needs to be remedied. The page also allows selection of the person who assessed the resident and the assessment date. The user may also indicate if the user refuses treatment or is otherwise unable to be treated. Finally, the page permits the user to print a Dental Services Request Document. The resident is then instructed to bring this form to the dentist so the dentist may provide details of the treatment provided.

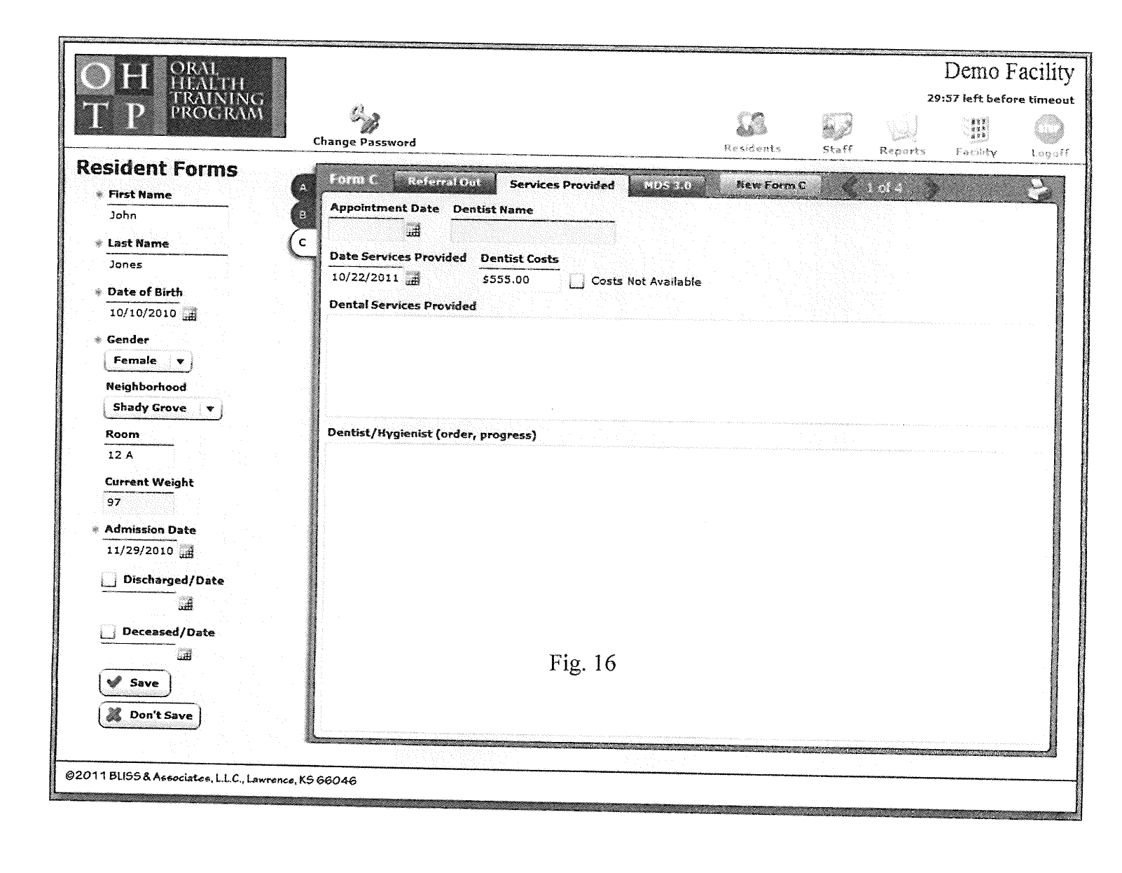

The Services Provided tab links to a page shown in FIG. 16 that allows a user to enter information provided by the dentist in the Dental Services Request Document after the dentist has seen the resident. For example, the user may enter the cost of the services provided and a summary of the services provided.

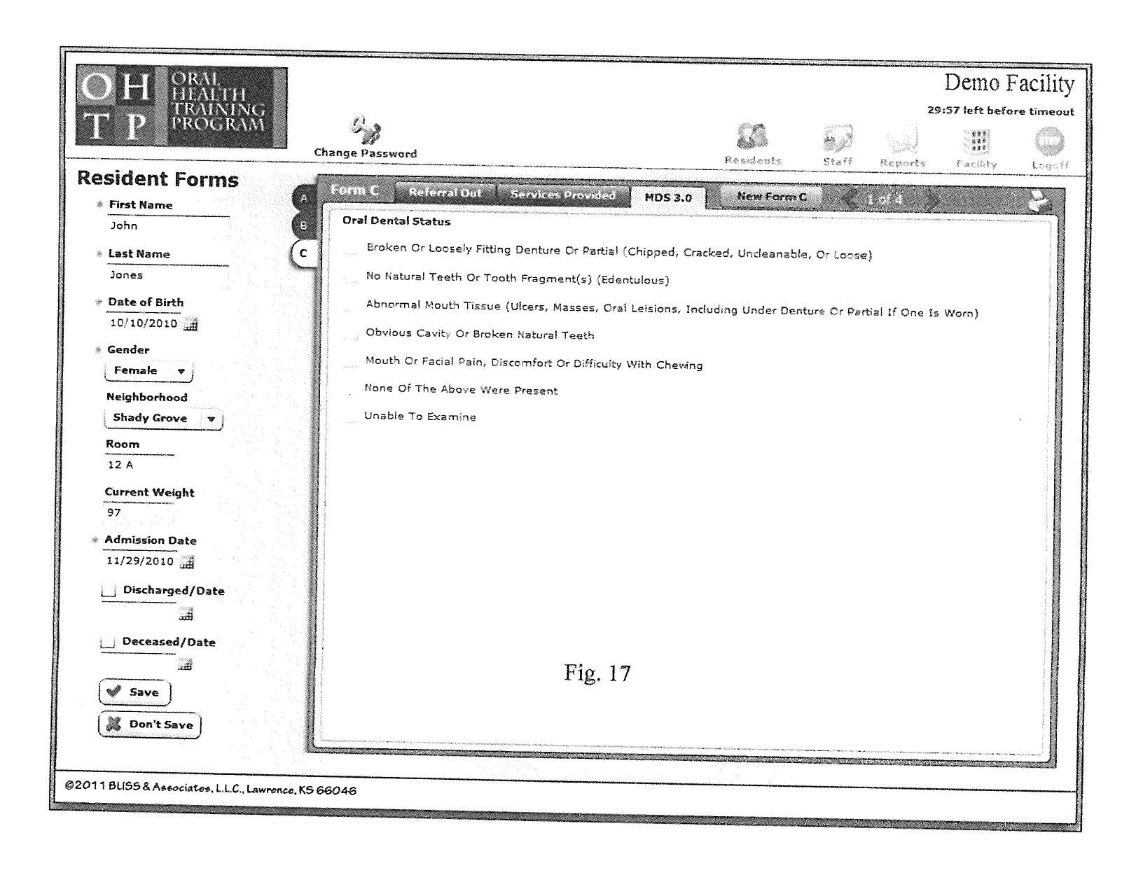

The MDS tab links to a page shown in FIG. 17 that allows users to indicate the MDS described above.

Form D is used to keep track of daily care provided for each resident and is discussed in more detail below in conjunction with the reports.

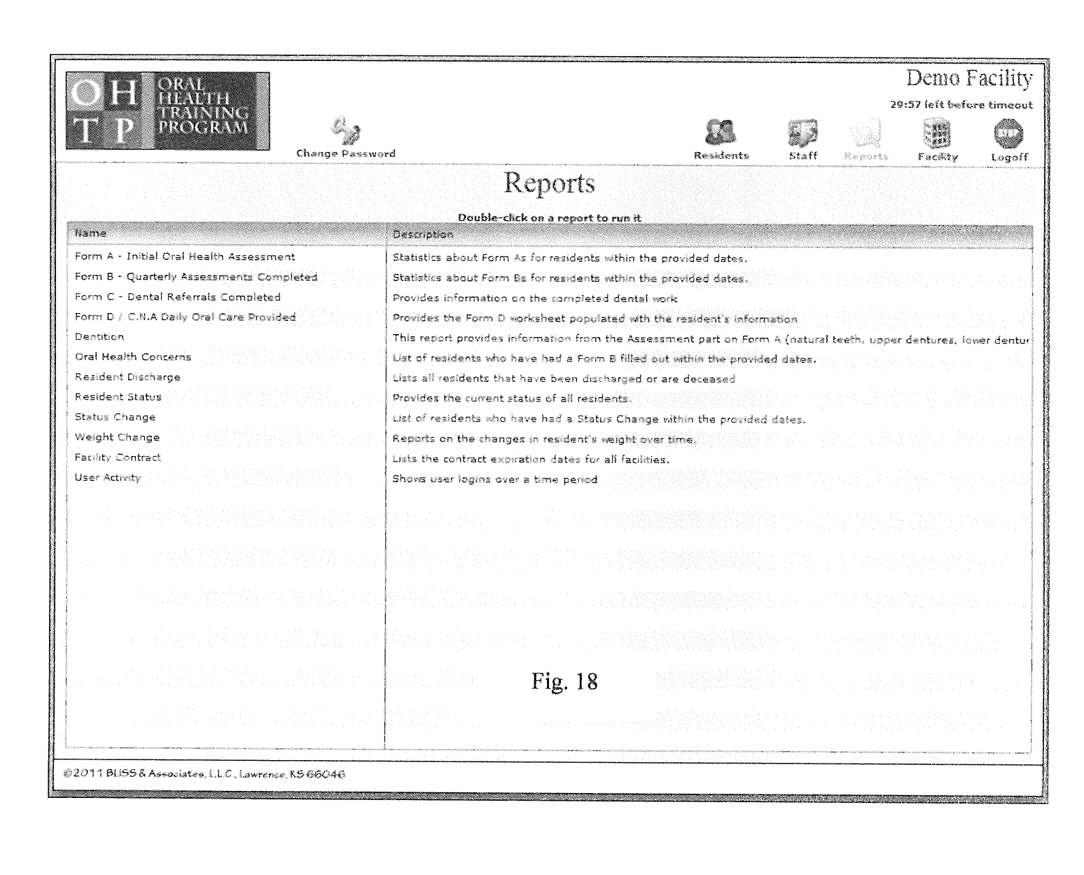

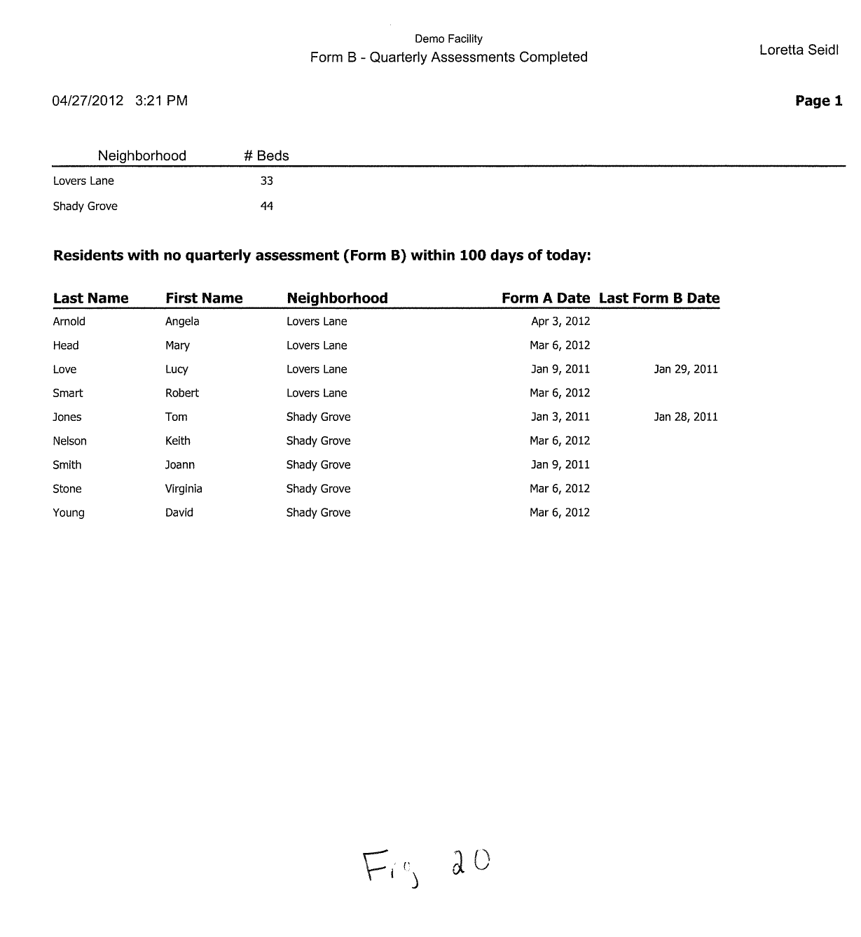

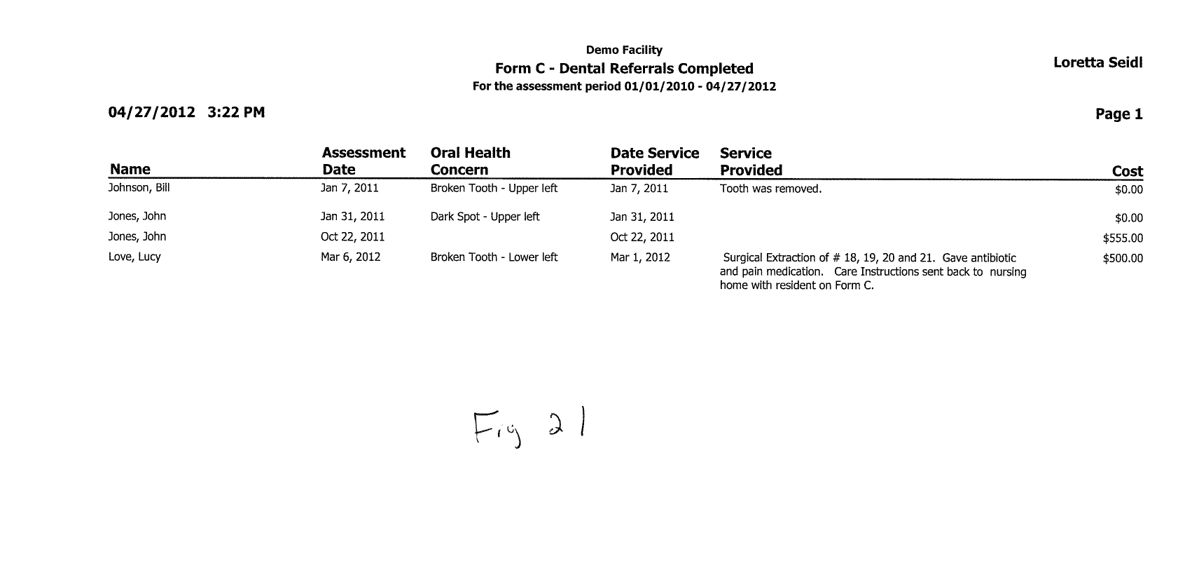

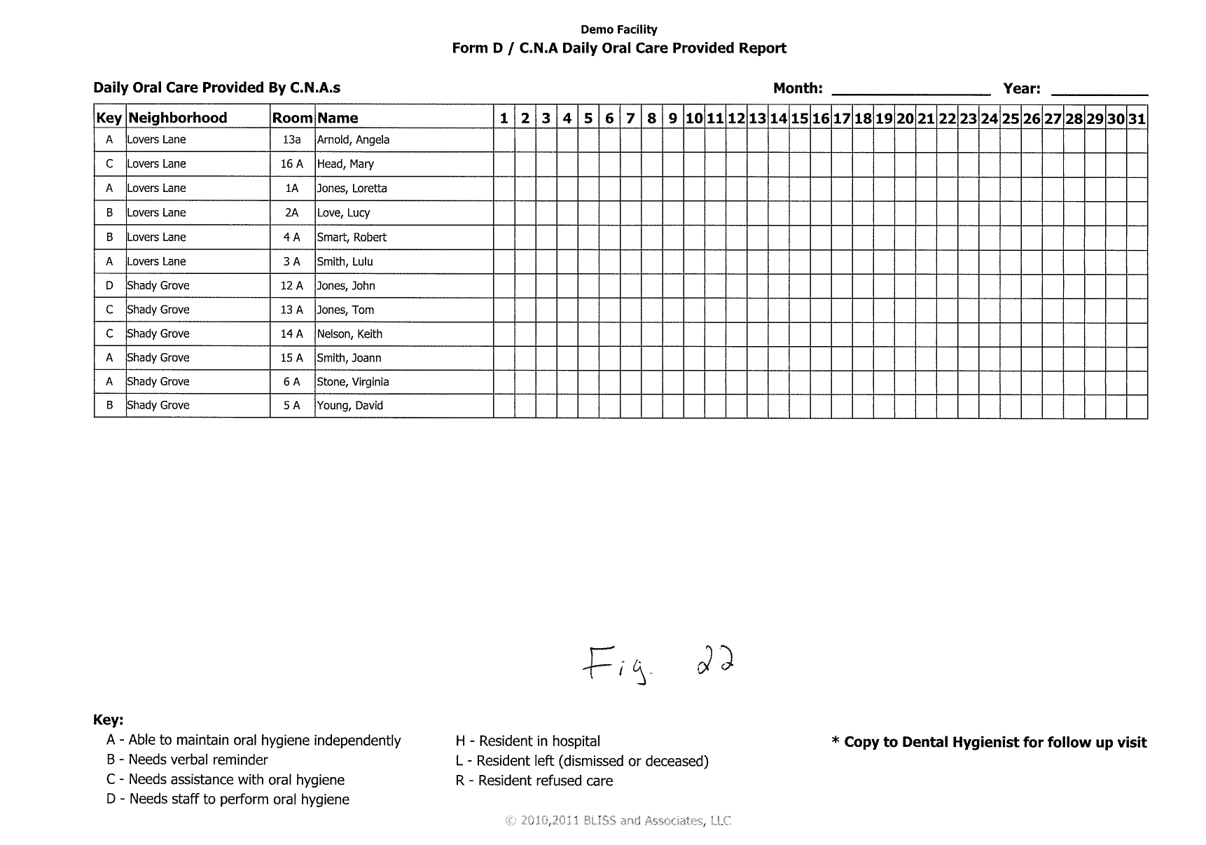

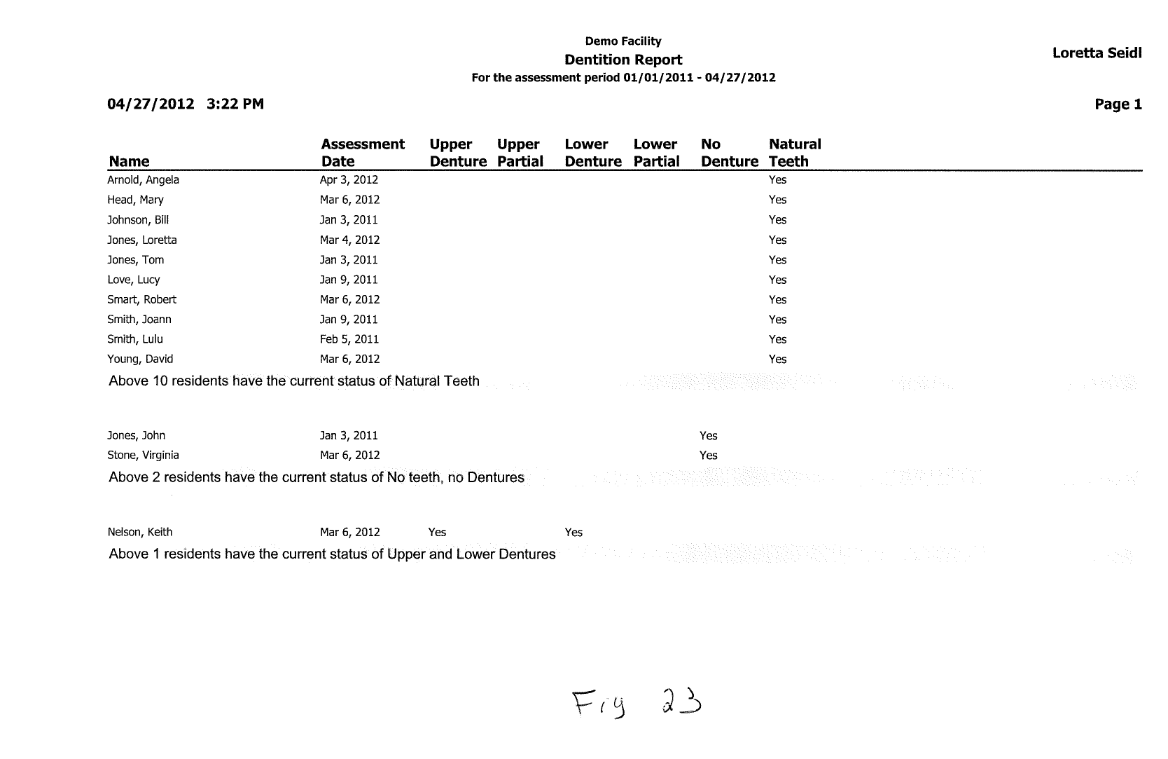

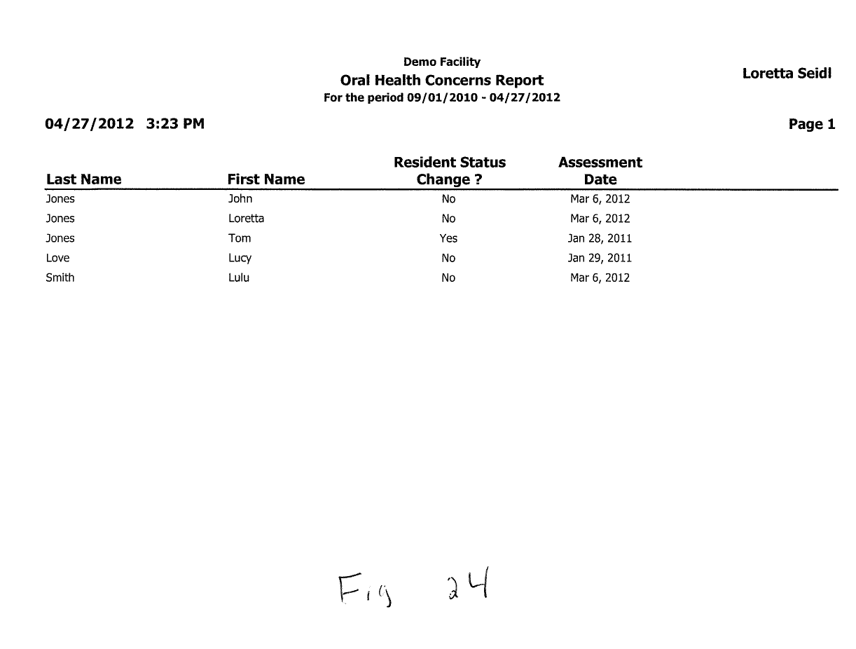

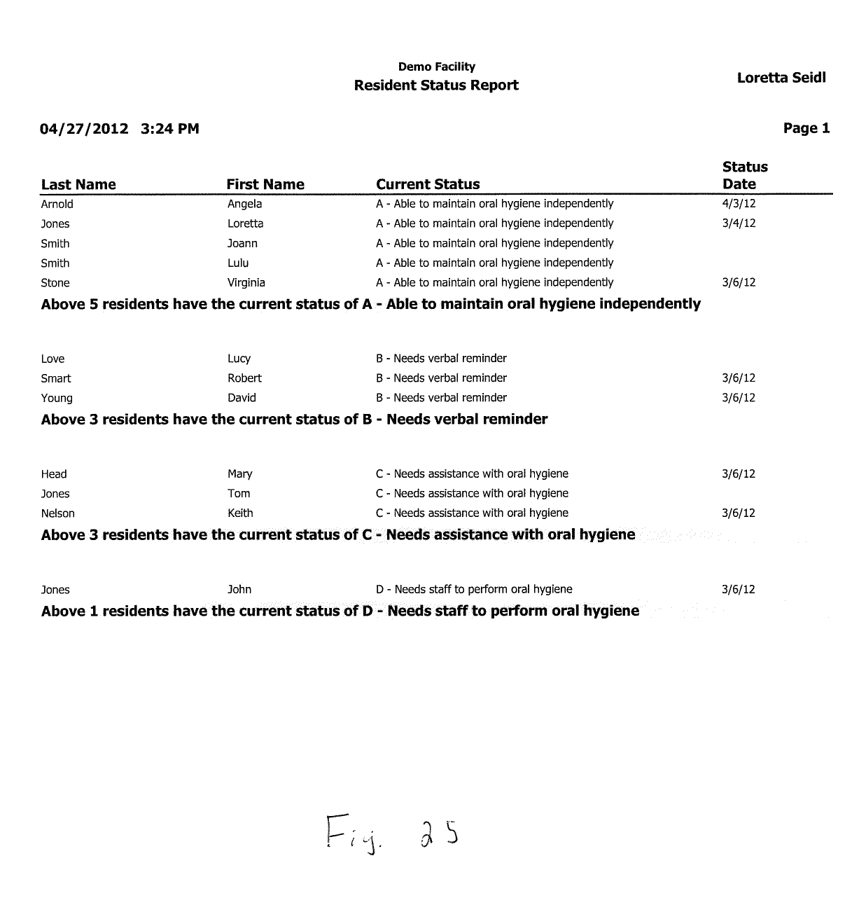

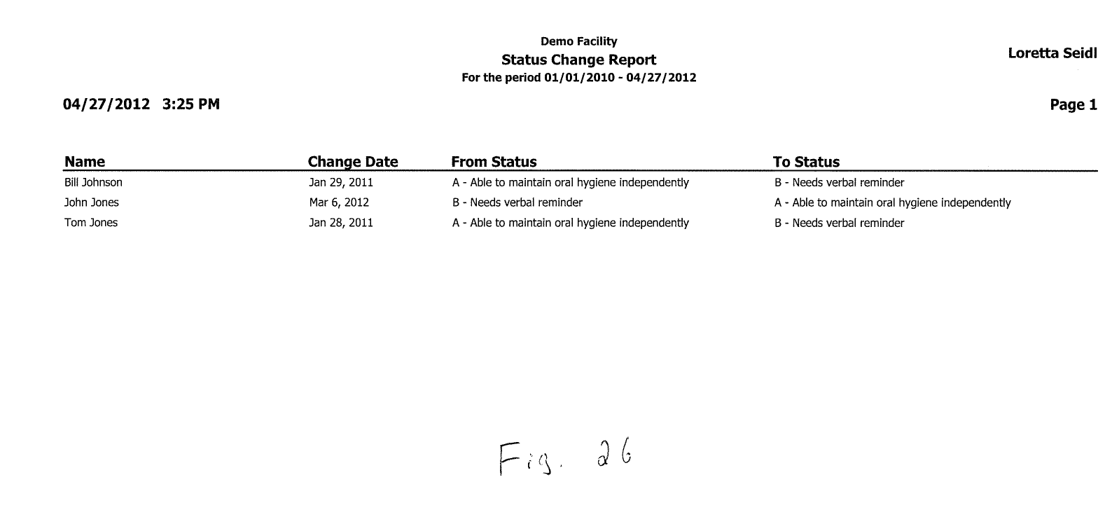

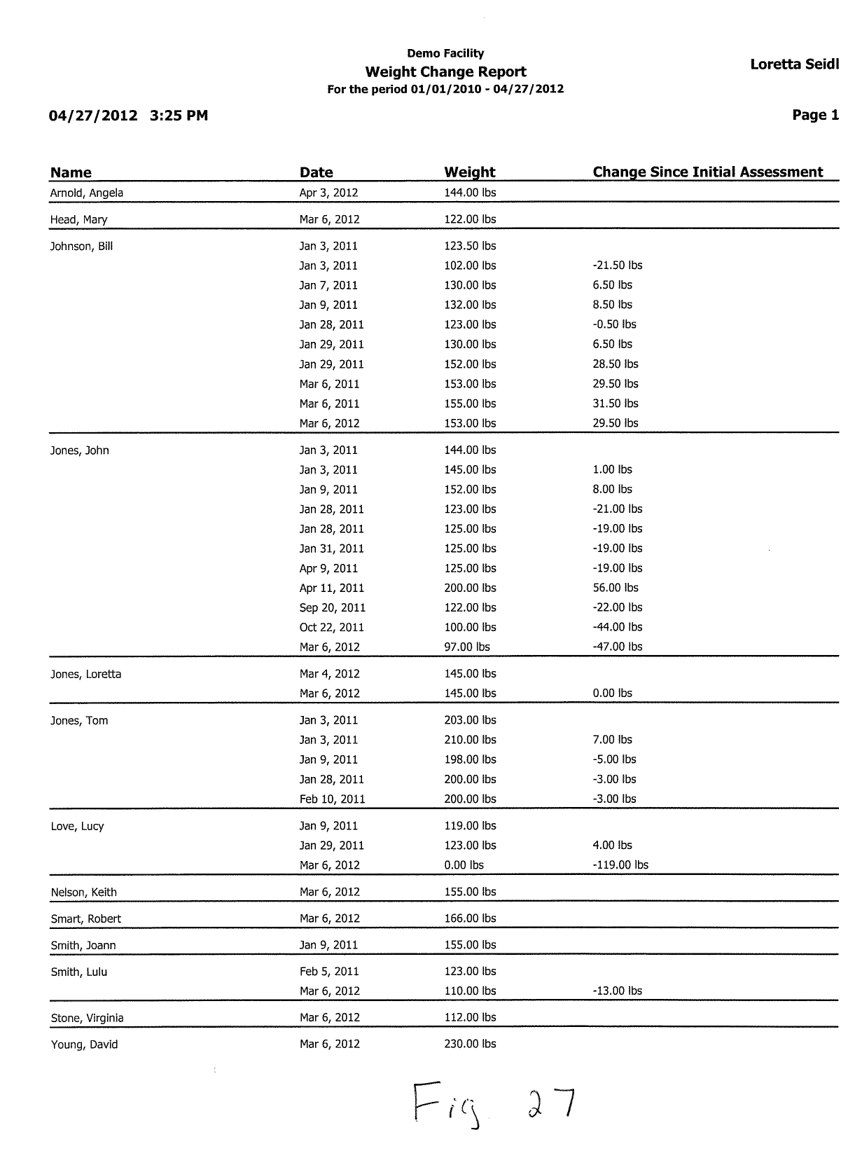

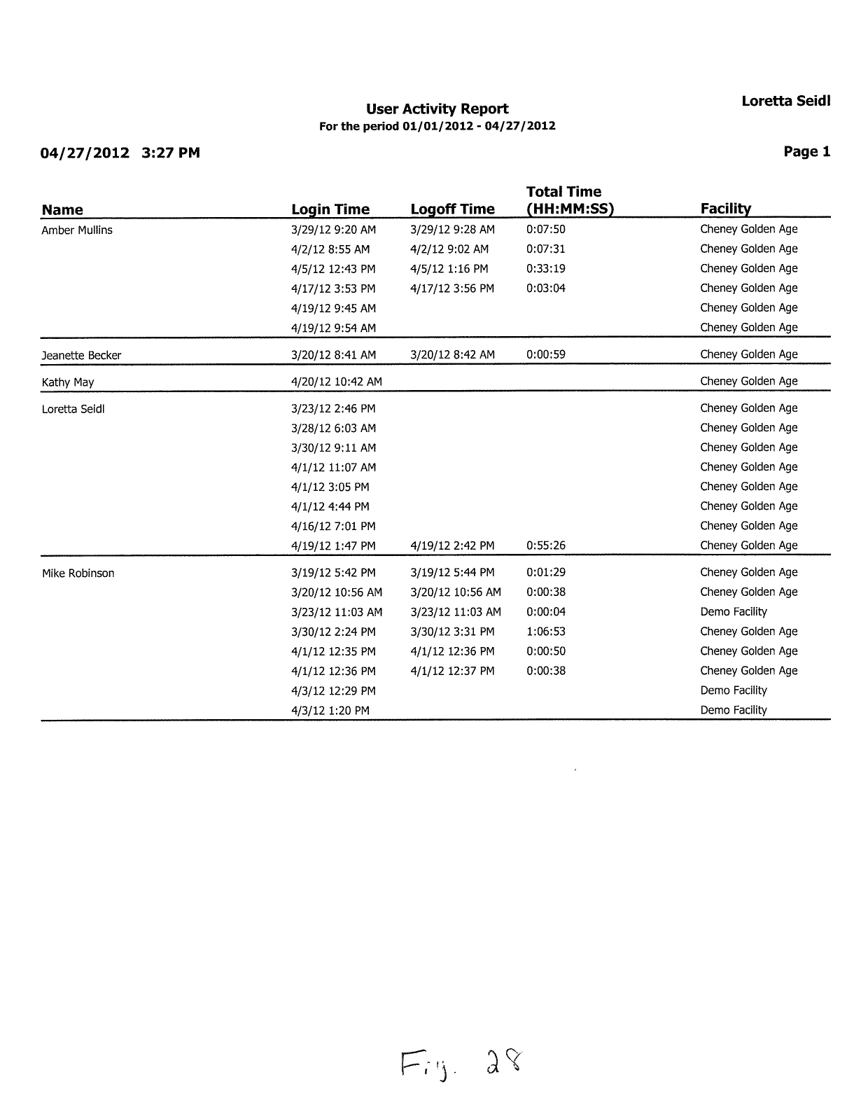

The Reports tab in the home screen of FIG. 4 allows the user to access various reports generated by the computer system as shown in FIG. 18. The reports may include:
A summary of Form A information for all residents that were assessed within a selected date range as shown in FIG. 19.
A summary of Form B information for all residents that were assessed within a selected date range as shown in FIG. 20.
A summary of Form C information for all residents that were assessed within a selected date range as shown in FIG. 21.
A summary of the daily oral care provided to the residents as entered into the Form D as shown in FIG. 22.
A Dentition report shown in FIG. 23 that provides information about the Residents' dentures from the Assessment part of Form A (natural teeth, dentures or partials). This report may be used for time management to help determine the amount of time needed by staff to assist with residents' oral care if they need assistance.
An Oral Health Concerns report shown in FIG. 24 that lists residents who had a Form B filled out within selected dates.
A Resident Report that lists residents who have been discharged or deceased within a selected time period.
A Resident Status Report shown in FIG. 25 that provides current oral health status for all residents in a facility.
A Status Change report shown in FIG. 26 that indicates residents with a changed status during a selected time period.
A Weight Change report shown in FIG. 27 that indicates each resident's weight change over time.
A Facility Contract report that lists contract expiration dates for facilities.
A User Activity report shown in FIG. 28 that shows user logins over a period of time. This report is used by administrators, to monitor staff use of the program as described above.

The present invention offers numerous advantages. For example, by providing a computer program specifically designed for use in collecting oral health care data for residents in a facility, and by tracking use of the program by caregivers in the facility, the caregivers are encouraged to use the program, which consequentially improves not only record-keeping at the facility but also the oral health care provided to the residents of the facility.

The present invention also allows an administrator to better manage the oral health care of each resident in a facility and to coordinate appropriate staffing levels for the overall facility. For example, if the computer program identifies a high percentage of residents who cannot perform their own oral health care, the administrator knows that additional caregivers are needed to perform oral health care. Similarly, if the program identifies a large number of residents have been admitted to the facility recently, the administrator knows that many of the residents need initial oral health care assessments.

Although the invention has been described with reference to the preferred embodiment illustrated in the attached drawing figures, it is noted that equivalents may be employed and substitutions made herein without departing from the scope of the invention as recited in the claims. For example, although embodiments of the invention may be implemented with the computer and communications equipment described herein, the invention is not limited to this particular computer and communications equipment.

Having thus described the preferred embodiment of the invention, what is claimed as new and desired to be protected by Letters Patent includes the following:

1. A computer program stored on non-transitory computer-readable medium for directing operation of a computer system for use in collecting, managing, and analyzing dental or oral health care data for residents in a facility, the computer program comprising:
a code segment for receiving and storing in the computer system profile data for at least some of the residents in the facility;
a code segment for permitting caregivers at the facility to access the profile data;
a code segment for receiving from the caregivers health care data representative of dental or oral health care provided to the residents;
a code segment for tracking when each caregiver uses the computer program to access the profile data or enter the health care data; and
a code segment for providing a usage report that indicates when each caregiver accesses the profile data or enters the health care data so that an administrator may assess usage of the computer program.

2. The computer program set forth in claim 1, wherein the usage report identifies all the caregivers who accessed the computer program in a selected time period, a time and date each caregiver accessed the computer program, and an amount of time each caregiver used the computer program.

3. The computer program set forth in claim 2, wherein the profile data for each resident includes the resident's name, facility room number, admission date, and a status indicator.

4. The computer program set forth in claim 3, wherein the status indicator for each resident indicates the resident is a) able to maintain his or her oral hygiene independently; b) in need of a reminder to perform oral hygiene; c) in need of assistance with oral hygiene; or d) in need of a caregiver to perform oral hygiene for him or her.

5. The computer program set forth in claim 4, further comprising a code segment for searching the profile data to identify all residents with the same status indicator.

6. The computer program set forth in claim 3, further comprising a code segment for searching the profile data to identify all residents with an admission date within a specified date range.

7. The computer program set forth in claim 1, further comprising a code segment for receiving in the computer system initial assessment data for each resident and storing the initial assessment data in a first form.

8. The computer program set forth in claim 7, wherein the first form identifies each resident's previous oral health care habits; aids used for the oral health care habits; oral habits; current oral health condition, and any oral or dental complaints.

9. The computer program set forth in claim 4, further comprising a code segment for receiving in the computer system updated assessment data for a resident and storing the updated assessment data in a second form when the resident receives a quarterly oral health care assessment, has a changed status indicator, or has a dental problem requiring a referral to a dentist.

10. The computer program set forth in claim 9, wherein the second form identifies a reason for the updated assessment data, identifies oral health concerns of the resident, and indicates the changed status indicator.

11. The computer program set forth in claim 1, further comprising a code segment for receiving in the computer system referral data for a resident and storing the referral data in a third form when the resident is to be referred to a dentist.

12. The computer program set forth in claim 11, wherein the third form identifies a dental problem requiring the referral and treatment provided by the dentist.

13. The computer program set forth in claim 12, further comprising a code segment for indicating the treatment provided by the dentist in the profile data for the resident.

14. A computer program stored on non-transitory computer-readable medium for directing operation of a computer system for use in collecting, managing, and analyzing oral health care data for residents in a facility, the computer program comprising:
a code segment for receiving and storing in the computer system profile data for at least some of the residents in the facility, wherein the profile data for each resident includes the resident's name, facility room number, admission date, and a status indicator, and wherein the status indicator indicates the resident is a) able to maintain his or her oral hygiene independently; b) in need of a reminder to perform oral hygiene; c) in need of assistance with oral hygiene; or d) in need of a caregiver to perform oral hygiene for him or her;
a code segment for permitting caregivers at the facility to access the profile data;
a code segment for receiving from the caregivers health care data representative of oral health care provided to the residents; and
a code segment for searching the profile data to identify all residents with the same status indicator.

15. The computer program as set forth in claim 14, further comprising:
a code segment for tracking when each caregiver uses the computer program to access the profile data or enter the health care data; and
a code segment for providing a usage report that indicates how often each caregiver accessed the profile data or entered the health care data.

16. The computer program set forth in claim 15, wherein the usage report identifies all the caregivers who accessed the computer program in a selected time period, the time and date each caregiver accessed the computer program, and an amount of time each caregiver used the computer program.

17. The computer program set forth in claim 14, further comprising a code segment for searching the profile data to identify all residents with an admission date within a specified date range.

18. The computer program set forth in claim 14, further comprising a code segment for receiving in the computer system initial assessment data for each resident and storing the initial assessment data in a first form.

19. The computer program set forth in claim 18, wherein the first form identifies each resident's previous oral health care habits; aids used for the oral health care habits; oral habits; current oral health condition, and any oral or dental complaints.

20. The computer program set forth in claim 14, further comprising a code segment for receiving in the computer system updated assessment data for a resident and storing the updated assessment data in a second form when the resident receives a quarterly oral health care assessment, has a changed status indicator, or has a dental problem requiring a referral to a dentist; and wherein the second form identifies a reason for the updated assessment data, identifies oral health concerns of the resident, and indicates the changed status indicator.

21. The computer program set forth in claim 14, further comprising a code segment for receiving in the computer system referral data for a resident and storing the referral data in a third form when the resident is to be referred to a dentist; and wherein the third form identifies a dental problem requiring the referral and treatment provided by the dentist.
